(19) United States
(12) Patent Application Publication
(10) Pub. No.: US 2009/0065532 A1
(43) Pub. Date: Mar. 12, 2009

(54) Dispensing device with secondary reservoir

(76) Inventor: Luc Marcel Lafond, Etobicoke (CA)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/718,640

(22) PCT Filed: Nov. 4, 2005
(86) PCT No.: PCT/CA2005/001692

§ 371 Date: May 4, 2007

(30) Foreign Application Priority Data
Nov. 5, 2004 (CA) 2,487,192

(51) Int. Cl. G01F 11/00; B67D 5/42

(52) U.S. Cl. 222/389; 222/386.5

(57) ABSTRACT

A hand held portable caulking gun dispenses sealant, caulking or other viscous fluid from a replaceable container received within a housing provided by the device. The caulking gun includes a first reservoir to receive a pressurized gas at a first operating pressure less than a first predetermined pressure. The pressurized gas is selectively released to express the viscous fluid. The first reservoir comprises an inlet for introducing the pressurized gas from a pressurized gas source. The first reservoir operates within a pressure range of about 80 psig (550 kPa) to about 250 psig (1720 kPa). A second reservoir operates within a pressure range of about 10 psig (70 kPa) to about 80 psig (550 kPa). The device defines a storage volume for an effective amount of pressurized gas sufficient to discharge the viscous fluid from the replaceable container.

### FIELD OF THE INVENTION

The following invention relates to portable, gas powered fluid dispensers, including caulking guns and other devices for dispensing viscous materials, including sealants, lubricants, pastes, epoxies, and other viscous materials. The present invention includes caulking guns, grease guns and other dispensers for viscous materials. The dispensing devices of the present invention will have application in various residential, commercial, construction and industrial applications in which viscous materials will be dispensed.

### BACKGROUND

Dispensable, viscous materials such as adhesives, epoxies, sealants, including caulking, pastes, lubricants, and other viscous materials are typically packaged in rigid, thermoplastic tubular containers, or spiral bound cardboard tubes. Some of these viscous materials come pre-packaged in tubular, flexible sausage-like containers.

Gas powered dispensers, including caulking guns, may be provided with a pressurized gas source such as a pre-charged CO2 cylinder, a detachable pressurized gas hose connected to a stationary or portable compressor, a hand pump or other suitable source. Examples of some recent dispensers are described in my copending U.S. patent application Ser. Nos. 10/629,270 and 10/793,180.

Earlier gas powered dispenser designs often require a pressure regulator to ensure that a suitable internal gas feed pressure is maintained while the unit is in operation, to dispense the caulking or other viscous material. In some earlier designs, the dispensers store the pressurized gas within a reservoir at relatively high pressures. The gas is stored in the reservoir at pressures substantially higher than what is needed to effectively operate the device and dispense the viscous fluid. For example, in some dispensing devices it is possible to develop internal gas storage and supply pressures of approximately 600-1000 psi (4130 kPa-6890 kPa) even though a much lower operating pressure could be used to dispense the viscous fluid. The pressure regulators needed to handle substantial pressure differentials, when compared to regulators used for comparatively modest pressure differentials, tend to be more complex and have special manufacturing requirements. There are usually special design requirements and added costs associated with using the more complex, high pressure regulators. Hence, there is a need for a dispensing device design without any pressure regulators or a device employing pressure regulators operating at relatively lower pressures.

### SUMMARY OF THE INVENTION

The present invention may be used with a wide variety of fluid containers, including caulking tubes and sausage-type containers, grease tubes, tubes containing sealants, adhesives, and mastics, prepackaged food stuffs in tube type containers, and the like. The invention may also be applied to handheld devices that may be powered by stationary compressors or battery powered portable air compressors, hand powered hand tools provided with hand operated air pumps, and other dispensing devices. Although certain examples and embodiments of the invention will be explained in connection with hand held portable devices, including caulking guns, the invention may be embodied in many other devices and other equipment for dispensing viscous materials. For example, caulking guns may be used to dispense a wide variety of viscous materials for use in manufacturing, construction, repair and other applications and activities. Certain embodiments of the invention may be adapted for operative fluid connection with external storage tanks (or supplemental reservoirs) capable of providing pressurized gas. However, preferred embodiments of the invention include hand held dispensing devices powered by internal pressurized gas reservoirs including air or CO₂. In certain preferred embodiments, the pressurized gases are charged in a removable and replaceable gas cylinder held within the device.

In one aspect, the invention is a hand held device suitable for dispensing a viscous fluid from a replaceable container stored within the device. The device includes a first reservoir for a pressurized fluid, for example, the pressurized fluid being pressurized air, pressurized CO2, or another suitable pressurized gas. The pressurized fluid is stored within the first reservoir at a first operating pressure which is less than a first predetermined pressure. The first reservoir is in fluid communication with a second fluid reservoir. The pressurized fluid stored in the second reservoir is stored at a second pressure which is less than the first predetermined pressure. The first reservoir is provided with an inlet for introducing the pressurized fluid from a pressurized fluid source. The pressurized fluid source may be provided internally, within the device, or the pressurized fluid source may be positioned outside of the device itself. In this embodiment, the device also includes a conduit for selective operative communication of the pressurized fluid from the second reservoir to express the viscous fluid from the device. For example, the device may be provided with a hand activated control so that the operator may selectively operate the device by permitting pressurized fluid within the second chamber to exert an operating pressure on the replaceable container, and in turn, express the viscous fluid from the device.

In a preferred embodiment, the first predetermined pressure is substantially greater than the second predetermined pressure. In one of the preferred embodiments, the first predetermined pressure is less than or equal to about 200 psig (1380 kPa). This first predetermined pressure is substantially less than supply pressures exerted by prepackaged CO2 cylinders, some of which may contain CO2 gas stored under pressures in the range of about 800 psig (5510 kPa) to about 1000 psig (6890 kPa) or more. In a more preferred embodiment, the first predetermined pressure will be less than or equal to about 150 psig (1030 kPa). In certain preferred embodiments, the second predetermined pressure will be less than or equal to about 80 psig (550 kPa). In certain other embodiments, the second predetermined pressure will be less than or equal to about 60 psig (410 kPa). In many instances, the second predetermined pressure will be chosen with regard to the most desirable operating pressures necessary to extrude viscous material from a removable cartridge or other container held within the dispensing device.

Skilled persons in the art will understand, upon a review of this specification, that in some instances, it may be desirable to adjust the second operating pressure to take into account differences in the operational characteristics of the removable containers for the viscous fluid. Similarly, it may be desirable to adjust the first operating pressure in certain circumstances. In certain embodiments, one or both of the first predetermined pressure and the second predetermined pressure will be adjustable via operator settings and controls.

In several embodiments of the invention it may be desirable to set a first predetermined pressure which is comparable to the input pressure ratings of readily available, low cost pressure regulators suitable for use in connection with operating pressures defined in part by the first predetermined pressure. It will be appreciated by those skilled in the art, that if the first predetermined pressure is lowered, it may become necessary to increase the volume of the first reservoir to provide sufficient pressurized fluid (for example, pressurized gas) to express a suitable quantity of viscous fluid from the device. For example, the volumes of the first reservoir and the second reservoir, and the first and second predetermined operating pressures may be designed so that a single charge of pressurized fluid (for example, pressurized gas) will be sufficient to dispense the entire contents of viscous fluid from at least one cartridge or other container of viscous fluid. However, other embodiments of the invention, for example those devices intended for use by non-professionals, may not have a sufficient reservoir volume to extrude a complete cartridge of viscous materials.

Many common gases exhibit behavior which is similar to that of an ideal gas when considered at ambient temperature and pressure conditions (72 degrees F. (22.2 degrees Celsius) and 1 atmosphere (101 kPa)). The ideal gas law states that:

PV=nRT

### Where:

P=Pressure; V=Volume; n=the number of moles of the gas that are present; R=the universal gas constant; and T=Temperature (in absolute temperature units, namely, in Kelvin).

Persons skilled in the art will appreciate that many viscous fluids used in the construction industry, for example, caulking, mastics, adhesives, and various sealants are formulated for use within relatively narrow temperature ranges of about 60 degrees F. (15.6 degrees C.) to about 90 degrees F. (32.2 degrees C.). If the operating pressure required to dispense a particular viscous fluid is known, the ideal gas law may be used to estimate the corresponding volume of certain pressurized gases required to power a caulking gun or other device of the present invention within a typical range of operating conditions.

Similarly, estimates of the required volume for a particular pressurized gas reservoir may be obtained by referring to published data for certain gases. By way of example, one pound (454 grams) of CO2 gas at 72 degrees F. (22.2 degrees Celsius) and 150 psig (1030 kPa) will occupy approximately 0.8 cubic feet (28,317 cm³).

Therefore, if it is intended to design a caulking gun or other powered device using standard CO2 cylinders containing 6 grams of CO2, and the maximum pressure of the first reservoir will reach 150 psig (1030 kPa) when the standard cylinder is discharged, the estimated minimum volume of the first reservoir will be calculated as follows:

Volume (approx.)=6 grams×(1 lb/454 grams)×0.8 ft³/lb×1728 in³/ft³=18.3 in³ (300 cm³).

Similarly, for a caulking gun to be powered by a standard 12 gram CO2 cylinder, operating at 72 degrees F. (22.2 degrees C.) and 150 psig (1030 kPa), the volume of the first reservoir (to be operated at a pressure higher than the predetermined pressure of the second reservoir) is estimated to be approximately 36.5 cubic inches (600 cm³).

In those embodiments where a pressure regulator is provided, the pressure regulator may be adjustable to operate within different pressure ranges. In some instances, the pressure regulator may be designed to operate within a range of predetermined incremental pressure settings such that the operator may adjust the pressure regulator by changing the pressure setting from one pressure setting to another pressure setting selected from a range of available settings.

In one embodiment of the invention, a hand held device for dispensing a viscous fluid from a replaceable container within the device, comprises:
a first reservoir for containing a pressurized fluid at a first operating pressure less than a first predetermined pressure, the first reservoir comprising an inlet for introducing the pressurized fluid from a pressurized fluid source;
the pressurized fluid expresses the viscous fluid from the replaceable container when the pressurized fluid is released; and
   the device defining a storage volume for an effective amount of the pressurized fluid sufficient to discharge substantially all of the viscous fluid from the replaceable container.

In another embodiment, the invention is a hand held dispensing device comprising:
a sealable chamber for receiving a cylindrical container of dispensable viscous fluid;
a nozzle defining a tip for selectively dispensing the viscous fluid from the chamber;
a first reservoir for containing a pressurized fluid below a first predetermined pressure, the first reservoir comprising an inlet for introducing the pressurized fluid from a pressurized fluid source;
a second reservoir for containing the pressurized fluid below a second predetermined pressure, the second reservoir being in fluid communication with the first reservoir, and the second predetermined pressure being less than the first predetermined pressure; and
the pressurized fluid within the second reservoir operating to express the viscous fluid from the sealable chamber via the nozzle tip.

In yet another embodiment, the invention is a hand held dispensing device comprising:
a cylindrical housing defining a sealable chamber for receiving: a cylindrical container of dispensable viscous fluid, the sealable chamber extending along a longitudinal axis and between a first end and a second end of the housing;
a nozzle adjacent the first end of the housing, the nozzle operating between a closed position and an open position;
a hand operated first control for operating the nozzle between the closed position and the open position;
a first reservoir for containing a pressurized fluid below a first predetermined pressure, the first reservoir comprising an inlet for introducing the pressurized fluid from a pressurized fluid source;
a second reservoir for containing the pressurized fluid below a second predetermined pressure, the second reservoir being in fluid communication with the first reservoir, and the second predetermined pressure being less than the first predetermined pressure;
the second reservoir being in fluid communication with the sealable chamber, to express the viscous fluid toward the first end when the cylindrical container is sealed within the sealable chamber; and
a hand operated second control for introducing the pressurized fluid into the second reservoir.

In a further embodiment, the invention is a hand held dispensing device comprising:
a cylindrical housing defining a sealable chamber for receiving: a cylindrical container of dispensable viscous fluid, the sealable chamber extending along a longitudinal axis and between a first end and a second end of the housing;
a nozzle adjacent the first end of the housing, the nozzle operating between a closed position and an open position;
a hand operated first control for operating the nozzle between the closed position and the open position;
a first reservoir for containing a pressurized gas below a first predetermined pressure, the first reservoir comprising an inlet for introducing the pressurized gas from a pressurized gas source;
the pressurized gas within the first reservoir being in fluid communication with the sealable chamber, when the pressurized gas is released, to express the viscous fluid via the nozzle when the cylindrical container is sealed within the sealable chamber; and
the device defining a storage volume for an effective amount of pressurized gas sufficient to discharge substantially all of the viscous fluid from the cylindrical container.

In some aspects, the dispensing device may be designed to couple with a detachable compressed air source, for example, a hand operated air pump. In that case, the first reservoir will be used to store compressed air received from the detach able air source, (for example, a hand operated air pump).

In some embodiments of the invention, the dispensing device may include one or more pressure relief valves to release excess pressurized fluid from one or both of the first reservoir and second reservoir. For example, a first pressure relief valve may be provided to relieve excess pressurized fluid from the first reservoir to prevent pressurization above the first predetermined pressure established for that reservoir. Similarly, a second pressure relief valve may be provided to relieve excess pressurized fluid from the second reservoir to prevent the pressure within that reservoir from exceeding the second predetermined pressure established for that reservoir. Conventional pressure relief valves may be provided to exhaust such excess amounts of pressurized fluid from the dispensing device. One or both of these pressure relief valves may also be designed to allow the operator to completely exhaust the pressurized fluid from the dispensing device. For example, in this embodiment, the operator may release the pressurized fluid in preparation for storage of the device after use, or to allow replacement or withdrawal of the container of viscous fluid from the dispensing device.

In some embodiments, it may be desirable to provide gauges or other visual displays to indicate to an operator, or others, the internal pressures existing within the first reservoir and the second reservoir. For example, a gauge may be provided to display the internal pressure within the first reservoir, to allow the operator to pressurize the first reservoir to a pressure not to exceed a predetermined maximum value.

In some aspects, the dispensing device of the present invention will be designed for use without a pressure regulator to modulate the flow of pressurized fluid from the first reservoir to the second reservoir. For example, in those instances, the operator may be able to satisfactorily pressurize the first reservoir up to the first predetermined limit by referring to a pressure gauge or other control element provided with the device. In other examples, the operator may release pressurized gas from the first reservoir to the second reservoir by operating a simple flow valve, until a pressure relief valve is activated to exhaust excess pressurized fluid from the first reservoir.

In some aspects, the dispensing device may include an expandable, protective liner for one or both of the interior storage spaces defined by the first reservoir and the second reservoir respectively. The liner may be made of a relatively pliable, yet resilient material such as rubber or other material suitable for preventing accidental leaks or discharges of pressurized fluid from the reservoirs. For example, the first reservoir may include a protective liner to prevent a potentially harmful explosion and discharge of fragments if the device is dropped or otherwise damaged while the first reservoir is pressurized. The liner may be designed to reinforce the outer walls of the first reservoir against disintegration if the reservoir is accidentally damaged. The protective liner may be co-extruded with a part defining the first reservoir, or the liner may be injection molded, sprayed on to the interior wall of the reservoir, or the liner may be provided using other methods.

The dispensing device of the present invention may provide one or more of the following advantages or other advantages which will become apparent upon a review of the present specification. By way of an example, one or more of the following advantages may be obtained:
Certain preferred embodiments of the dispensing device will dispense viscous materials at a variable flow rate. The dispensing device may include compatible nozzle assemblies, or nozzle tips and replaceable components.
Certain embodiments of the invention may be adapted for use with rigid, tube type containers and with sausage type containers for dispensable fluids.
In some instances, a compatible reusable, and reattachable nozzle assembly may be provided, to be fully interchangeable with other nozzle components, and capable of providing variations in flow volumes, patterns and extruded bead sizes.
The dispensing device may be compatible with a range of pressurized fluid sources. For example, some devices may be compatible for charging with pressurized air from stationary or movable compressors, portable gas sources such as large, pre-filled cylinders or vessels, hand operated air pumps, and other externally powered sources. In some instances, it may be desirable to provide a chamber within the handle of the device to receive a pressurized CO₂ cartridge, or other filled gas cylinder.
In some embodiments, the first reservoir may be replenished occasionally with compressed gas by connecting the first reservoir to a compressed gas source.
The first reservoir may also be a modular unit suitable for replacement with different reservoirs, or the first reservoir may be compatible for adding supplementary reservoirs to increase the storage capacity for compressed gas.
One or more of these advantages, or other advantages, may be available to those who use embodiments of the present invention.

The foregoing are only some examples of certain embodiments of the invention. Many other embodiments, variations and derivations will become apparent from a review of the entire description, including the appended drawings.

### IN THE DRAWINGS

Certain specific embodiments of the invention will be described with reference to the following drawings in which:

FIG. 1a is a schematic representation of the major components of a preferred embodiment of the invention.

FIG. 1b is a schematic representation of a second preferred embodiment of the present invention.

FIG. 1c is a schematic representation of another embodiment of the present invention.

FIG. 1d is a schematic representation of a further embodiment of the invention.

FIG. 2a is a side view, in partial section, of an embodiment of the invention adapted to receive pressurized air from a hand operated pump.

FIG. 2b is an end view of one component of the embodiment shown in FIG. 2a.

FIG. 2c is a front view of another embodiment of the invention, wherein the device comprises an integral hand operated air pump.

FIG. 3 is a side view, in perspective, of another embodiment of the present invention.

FIG. 4a is an exploded side view of another embodiment of the present invention wherein the device is powered by a pressurized gas cylinder.

FIG. 4b is an exploded side view, in partial section, of certain components of the embodiment shown in FIG. 4a.

FIG. 4c is an enlarged sectional view of one of the components in FIG. 4b, and including an enlarged end view of another of the components of the embodiment shown in FIG. 4b.

### DETAILED DESCRIPTION

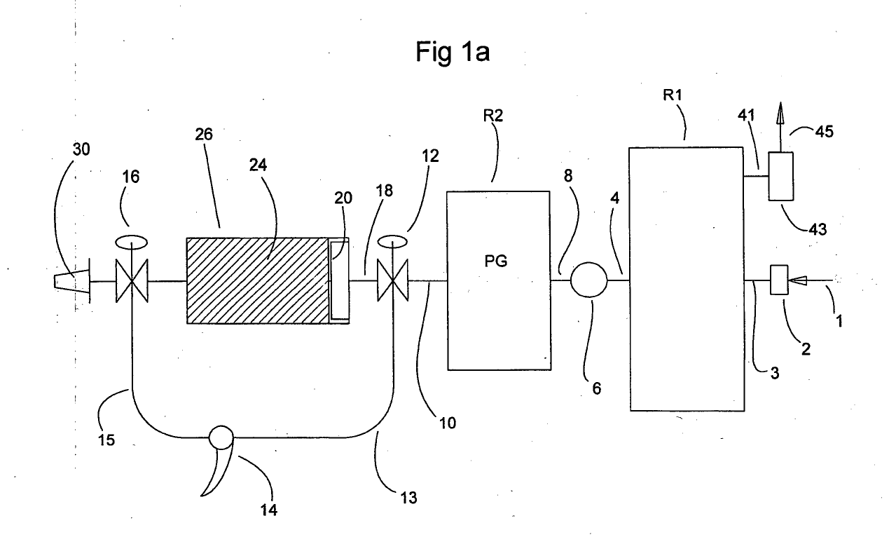

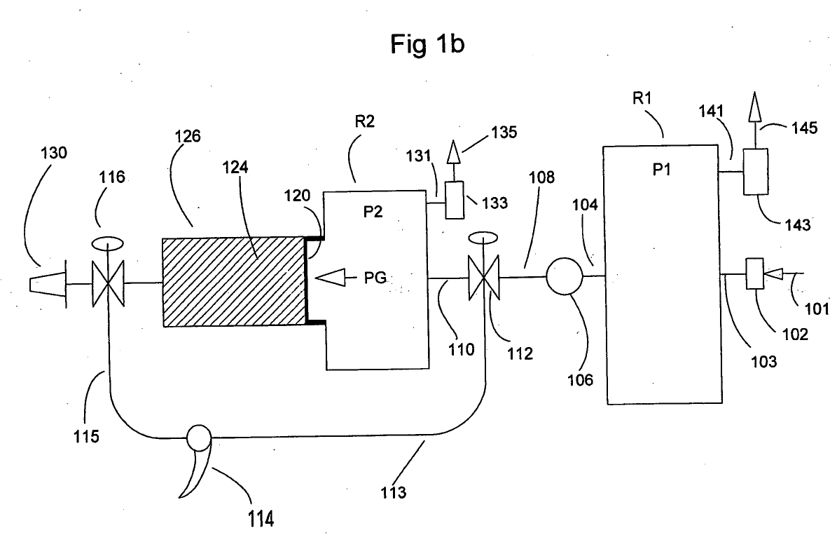

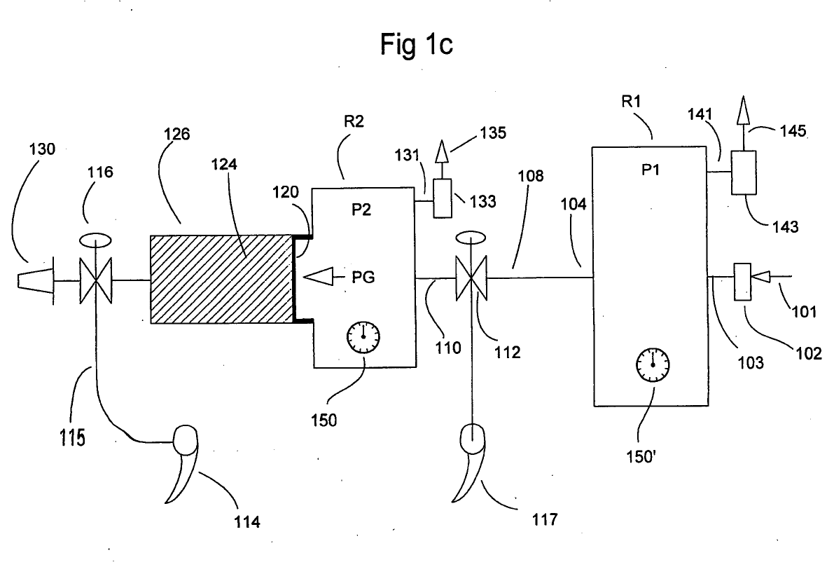

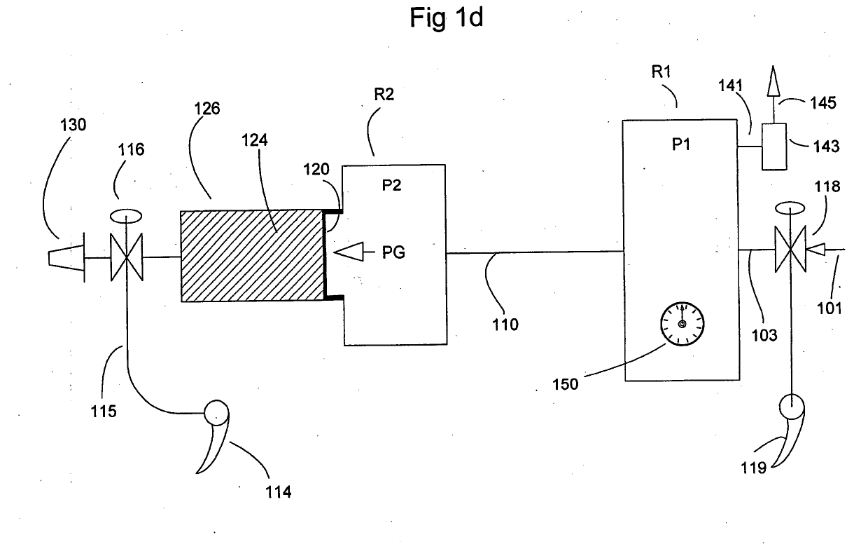

With reference to FIG. 1a, a preferred embodiment of the invention is shown in schematic representation. A dispensing device includes a first reservoir R1 and a second reservoir R2. The first reservoir R1 is supplied with pressurized gas from a source 1 through an inlet element including a one way valve 2 and inlet conduit 3. By way of example, in a hand help portable caulking gun, the source 1 may be a small, single use cylinder filled with CO2 gas received within a chamber within the handle portion of the hand held caulking gun. In such an embodiment, the single use cylinder may be replaced with another prefilled cylinder when the first is emptied. In other embodiments, the source 1 may also be located outside of the dispensing device, by a larger, multi-use, prefilled cylinder or tank filled with compressed air or other gases, an air compressor, compressed air hose, air pump (hand operated or powered) or other powered source of compressed gas.

Reservoir R1 is pressurized to a maximum predetermined pressure P1. In a typical hand held portable gas powered caulking gun, the maximum pressure P1 will be determined with reference to the applicable design requirements for a particular application. Where it is desirable to use relatively low cost, mass produced pressure regulators of the type often used in other pressurized gas powered devices, the maximum pressure P1 setting for reservoir R1 will be about 200 psig (1380 kPa), and preferably about 150 psig (1030 kPa). To ensure that the maximum predetermined pressure P1 within reservoir R1 does not exceed the maximum pressure rating of the pressure regulator 6, the pressure P1 is controlled by a pressure relief valve 43, connected to reservoir R1 through a conduit stem 41, and the pressure relief valve 43 is vented to the outside of the dispensing device through exhaust opening 45. Pressure relief valve 43 is preset to exhaust excess pressurized gas from reservoir R1 if the pressure of the gas contained therein exceeds the predetermined pressure limit P1.

A conduit for fluid communication between reservoirs R1 and R2 is defined by a first channel segment 4, which communicates with a second channel segment 8, through an intermediate pressure regulator 6. In this embodiment, the pressure regulator 6 is provided, although other embodiments of the invention will not require a pressure regulator. The pressure regulator 6 may be designed with a number of adjustable, pressure settings within a predefined range of incremental settings.

In alternative embodiments, the pressure regulator may have a number of factory preset pressure limits which are selectable by the operator for use in dispensing various fluids. For example, in a preferred embodiment intended for use with several dispensable fluids of different viscosities, it may be desirable to provide operator selectable, preset operating pressure limits of 10 psig (70 kPa), 20 psig (140 kPa), 30 psig (210 kPa), 40 psig (280 kPa), and 70 psig (480 kPa) for the pressurized gas within the second reservoir, R2. Of course, other preset pressure limits may be provided for use in connection with other dispensable fluids. The pressure regulator 6 may be used to regulate both the upper and lower pressure limits for the pressurized gas in the second reservoir R2. The maximum pressure of the pressurized gas in reservoir R2 will be a predetermined value of P2.

With reference to reservoir R2 in this embodiment as shown in FIG. 1a, it may also be desirable to provide a corresponding pressure exhaust valve (not shown) to allow an operator to completely evacuate pressurized gas from the interior of reservoir R2, for example, when the operator is servicing or storing the dispensing device. Where such an added feature is provided, the pressure exhaust valve may be provided in the form of a pressure relief valve which may also be manipulated by the operator to completely exhaust pressurized gas from reservoir R2 to the surrounding environment.

Pressurized gas PG at pressure P2 is supplied to act on the contents of a tubular container 26 of viscous fluid 24 (for example, caulking material) via conduit portions 10, 18 and through supply valve 12. In this example, the pressurized gas PG exerts a pressure on a sliding plunger 20 which in turn acts on the viscous fluid 24. The opening and closing of supply valve 12 is activated by an operator control, in this example, a finger activated trigger 14 which is operatively connected to adjustable valve 12 via linkage 13. Trigger 14 is also operatively connected to a dispensing valve 16 through linkage 15. When the trigger 14 is activated, pressurized gas PG is allowed to pass through valve 12, to act on plunger 20, causing viscous fluid 24 to be expressed through opened dispensing valve 16, and out through dispensing nozzle 30. When trigger 14 is released, valves 12 and 16 are closed and the dispensing flow of viscous fluid 24 is stopped. Although this example illustrates a common control element, namely trigger 14, for both valves 12 and 16, other embodiments may provide separate operator activated controls (not shown) for valves 12 and 16.

With reference to FIG. 1b, a second preferred embodiment of the invention is shown in schematic representation. A dispensing device includes a first reservoir R1 and a second reservoir R2. The first reservoir R1 is supplied with pressurized gas from a source 101 through an inlet element including a one way valve 102 and inlet conduit 103.

Reservoir R1 is pressurized up to a maximum predetermined pressure P1. In this embodiment, pressure relief valve 143 is preset to exhaust excess pressurized gas from reservoir R1 if the pressure of the gas contained therein exceeds the predetermined pressure limit P1. The predeterimined pressure P1 is ensured by the pressure relief valve 143, connected to reservoir R1 through a conduit stem 141, and the pressure relief valve 143 is vented to the outside of the dispensing device through exhaust opening 145.

Reservoirs R1 and R2 are interconnected for fluid communication through channel segment 104, pressure regulator 106, channel segment 108, flow control valve 112, and channel segment 110. In this embodiment, a pressure regulator 106 is also provided, although other embodiments of the invention will not require a pressure regulator. Persons skilled in the art will appreciate that some embodiments of the invention may be designed to utilize a pressure regulator incorporating a flow valve as an integral part of a single piece.

The maximum pressure of the pressurized gas in reservoir R2 will be a predetermined value of P2. Typically, the predetermined maximum pressure in reservoir R1 will be substantially higher than the predetermined maximum pressure in reservoir R2. In a most preferred embodiment of the invention, for use in hand held portable caulking gu ins, the predetermined pressure in reservoir R1 will range between about 80 psig (550 kPa) and 250 psig (1720 kPa), preferably between about 150 psig (1030 kPa) and 250 psig (1720 kPa), and most preferably, less than or equal to 200 psig (1380 kPa), and the predetermined pressure in reservoir R2 will range between about 10 psig (70 kPa) and 80 psig (550 kPa).

In other embodiments of the invention, for example, those dispensing devices to be used by the do-it-yourself market segment, may be designed to partially dispense a single container of viscous dispensable material. It will be expected that certain do-it yourself users will not need to dispense a full container of caulking, sealant or other dispensable material for each charge of pressurized gas introduced into the first reservoir of the dispensing device. In certain instances, relatively small, lightweight and less expensive embodiments may be designed to operate below a first predetermined pressure P1 within the first reservoir R1, P1 being within a range of about 25 psig (170 kPa) to about 50 psig (340 kPa). In these instances, the volume of the second reservoir may be relatively small, and substantially less than the volume occupied by the first reservoir. However, the volume of the second reservoir may be designed to be an optimal size to ensure that the operating pressure within the second reservoir does not drop below a minimum pressure necessary to dispense viscous materials under typical operating conditions. Preferably, the flow rate of pressurized gas flowing into the second reservoir will be sufficient to maintain the operating pressure within acceptable pressure ranges within the second reservoir as the viscous material is being dispensed from the device.

With reference to reservoir R2 in this embodiment as shown in FIG. 1b, a pressure exhaust valve 133 is connected to reservoir R2 for fluid communication through conduit 131. The exhaust valve opens to the environment through outlet 135 when the internal gas pressure within reservoir R2 exceeds the predetermined pressure limit for that reservoir. The pressure relief valve 133 is provided to allow an operator to completely evacuate pressurized gas from the interior of reservoir R2, for example, when the operator is servicing or storing the dispensing device. The pressure relief valve may be manipulated by the operator to completely exhaust pressurized gas from reservoir R2 to the surrounding environment.

Pressurized gas PG is supplied at a pressure P2 to act on the contents of a tubular container 126 of viscous fluid 124 by exerting a pressure on a sliding plunger 120 within the tubular container. The sliding plunger 120 in turn acts on the viscous fluid 124. The opening and closing of supply valve 112 is activated by an operator control, trigger 114. The trigger 114 is operatively connected to adjustable valve 112 via linkage 113. Trigger 114 is also operatively connected to a dispensing valve 116 through linkage 115. When the trigger 114 is activated, pressurized gas PG is allowed to pass through valve 112, to act on plunger 120, causing viscous fluid 124 to be expressed through simultaneously opened dispensing valve 116, and out through dispensing nozzle 130. When trigger 114 is released, valves 112 and 116 are closed simultaneously and the dispensing flow of viscous fluid 124 is stopped. In this embodiment, the volume of R2 will tend to increase as the plunger 20 advances within the tubular container 126 toward dispensing nozzle 130. By way of example, in some embodiments, the initial volume of reservoir R2 may range between about 20 cm³ and 60 cm³ or more when the tubular container is full. However, in a dispensing device for use with a typical tubular container containing approximately 300 cm³ of viscous construction material (for example, caulking), the volume of R2 may exceed 300 cm³ as the container is substantially emptied of the viscous material.

Although this embodiment includes a single operator control element, trigger 114, which simultaneously acts on the gas supply valve 112 and dispensing valve 116, other embodiments may include separate operator controls for the flow of pressurized gas and flow of dispensable material, respectively. The operator may be provided with separate control elements to allow independent operation of the corresponding flow controllers (such as for example, valves 112 and 116).

By way of example, FIG. 1c illustrates an embodiment similar to the one shown in FIG. 1b, however, separate operator control elements are provided. In the embodiment of FIG. 1c, the first control element is a first trigger 114 operatively connected to dispensing valve 116 via linkage 115. However, a second operator control element, namely a second trigger 117, is operatively connected to adjustable valve 112. In this embodiment, a pressure regulator 106 (as shown in FIG. 1b) is not provided. Instead, pressure indicators 150 and 150′ are provided to inform the operator of the pressures within corresponding reservoirs R2 and R1.

FIG. 1d illustrates yet another variant having separate operator control elements to independently operate corresponding flow controllers, without a pressure regulator. In this example, trigger 114 is operatively connected to dispensing valve 116 via linkage 115. In this simplified design, reservoirs R1 and R2 are in direct fluid communication via conduit 110. In this example, the pressures of both reservoirs are essentially the same. The two reservoirs define a storage volume for an effective amount of pressurized gas sufficient to discharge substantially all of the viscous fluid from the container 126. (The term “substantially all” is intended to capture those instances in which all of the viscous fluid has been dispensed from the container 126 and those instances in which an insignificant amount of viscous fluid is left behind within the container 126.)

In this example, pressurized gas is supplied from a pressurized gas source 101. A second control element, which in this example is a second trigger 119, is operatively linked to a supply valve 118. When supply valve 118 is opened by operation of trigger 119, pressurized fluid is introduced into the storage volume defined by the dispensing device in this example. The operator is informed of the charge pressure P1 by referring to pressure indicator 150. The operator will be able to identify when the charge pressure for the incoming pressurized gas reaches the predetermined pressure for the storage volume. It will be understood that the predetermined pressure limit in some instances may correspond to an amount of pressurized gas which is more than sufficient to discharge all of the viscous fluid from the container 126. In this example, reservoir R1 is provided with a pressure relief valve 143 connected with reservoir R1 via conduit 141. Under predetermined conditions, pressurized gas is exhausted from the device via reservoir R1, through relief valve 143, and out exhaust outlet 145. For example, the pressure relief valve 143 may be designed to open at a preset limit to ensure safe operation of the device. The preset limit for the relief valve 143 may be substantially higher than the predetermined pressure for the storage volume sought by the operator during normal operations.

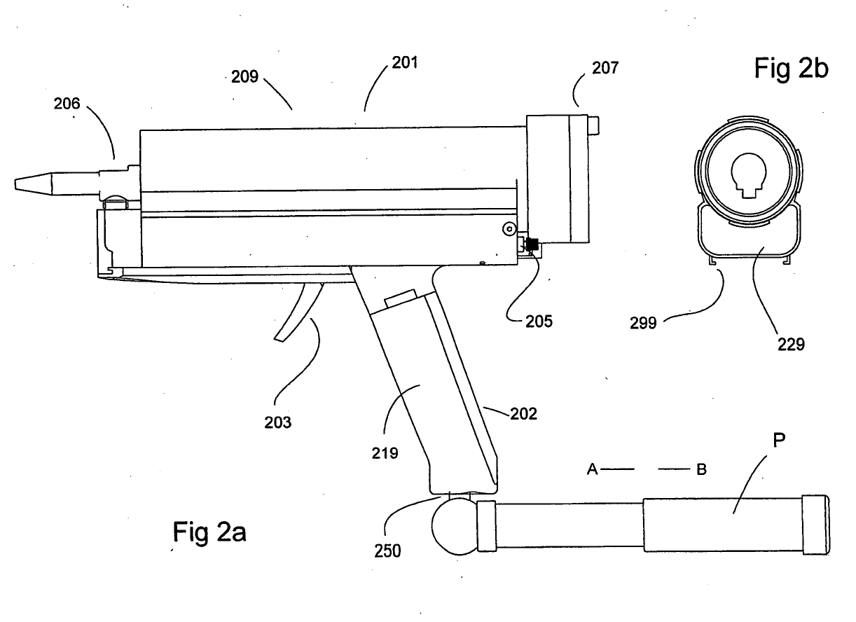

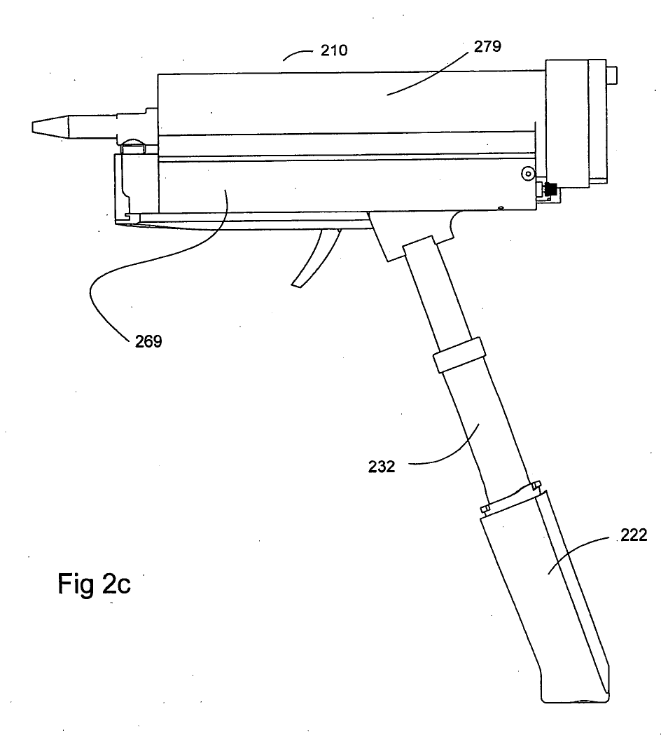

FIG. 2a shows an embodiment of a dispensing device in which pressurized gas is stored within a first storage reservoir 219 in the handle grip 202 of the caulking gun 201. An elongated cylindrical housing 209 receives conventional pre-filled tubes of caulking through a removable, and sealable, end cap 207. In this embodiment, although not illustrated in detail, the conventional caulking tube is placed into the housing, so as to be in fluid communication with a variable flow nozzle assembly 206 positioned at the dispensing end of the caulking gun. A finger activated trigger 203 may be used to operate the variable flow nozzle through a range of positions between the fully closed and fully open positions. When the trigger 203 is activated by the operator, the trigger also acts on an internal valve assembly (not shown) to release pressurized gas from reservoir 229, to exert operative force on the contents of the caulking tube, to express caulking through the variable flow nozzle.

A detachable, hand operated air pump P is coupled with air valve 250 so that pumping action of the pump handle (indicated by arrows A, B) will charge the first reservoir 219 with air. The pump may be used to recharge the reservoir 219 with pressurized air as needed to dispense fluids from the device. FIG. 2b shows an end view of a removable housing 209 which includes a second reservoir 229 for storage of compressed air received from the hand operated pump P. In this embodiment, the removable housing 209 is secured to the base of dispensing device 201 along tracks 299 which engage with corresponding recesses (not shown) defined within the base 205. Of course, other features may be used to removably secure the housing to the base of the dispensing device 201. It will also be appreciated that the first reservoir 219 (and in some instances, the second reservoir 229) may have multiple compartments for storage of pressurized gas. Each reservoir may be provided with separate pressure relief valves (not shown) to selectively control the predetermined maximum pressures (P1 and P2) of the pressurized gas contained within the respective reservoirs 219 and 229. In some embodiments, it may also be desirable to have gauges with visible displays to show the operating gas pressures within the respective reservoirs so that an operator will be able to monitor, and adjust those operating pressures when necessary. For example, a gauge may be used to alert an operator to an undesirable drop in pressure within one of the reservoirs, for example, the first reservoir 219. When alerted, the operator may use the air pump (or other pressurized gas source) to increase the pressure of the gas stored within first reservoir 219.

FIG. 2c illustrates another embodiment of a caulking gun powered by an integral hand operated air pump. In this embodiment, caulking gun 210 has a body 269 which includes a housing 279. The body 269 has a first portion in which the first reservoir (not shown) is provided. The body 269 also has a second portion of sufficient size to enclose the second reservoir (not shown). In a preferred embodiment, the second reservoir is provided in the housing 279, surrounding the interior space occupied by the caulking tube when the tube is loaded within the caulking gun 210. In this case, the operator is able to load the first reservoir with compressed air by unlocking handle grip 222, and compressing and extending telescopic pump 232 along its longitudinal axis until the desired pressure is attained within the first reservoir. In some embodiments, which are not specifically illustrated herein, the caulking gun may include an independently operated control element. The independently operated control element will allow the operator to open the conduit between the first and second reservoirs independently of any dispensing flow of viscous fluid, and thereby allow pressurized air to enter the second reservoir, when desired by the operator. In some instances, the device may be designed so that the operator may pressurize both reservoirs R1 and R2 to their respective predetermined pressures during a single filling step.

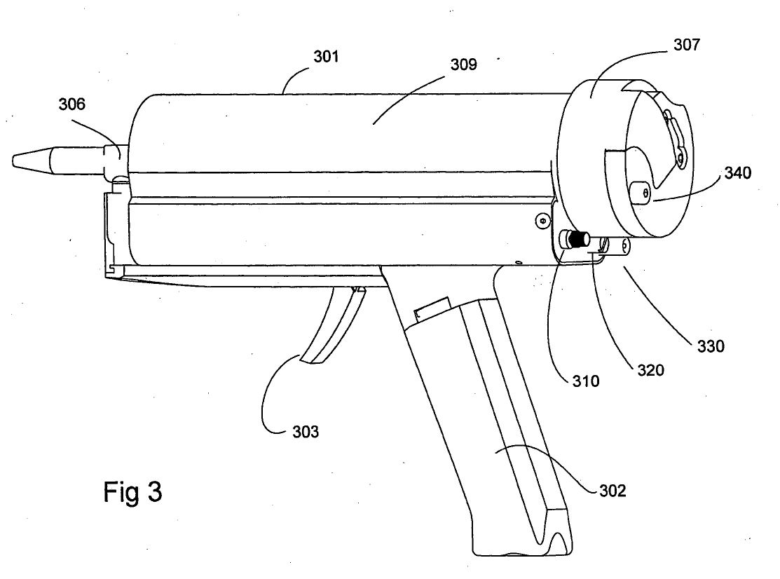

FIG. 3 illustrates another embodiment of a caulking gun 301 having a housing 309 for a replaceable caulking tube (not shown). The caulking tube is loaded into the housing 309 through a removable end cap 307. At the opposite end of the caulking gun, a nozzle 306 is provided for fluid communication with the contents of the caulking tube, when the tube is loaded in the caulking gun. A trigger 303 is provided to operate both the nozzle and an interior operating valve (not shown). When the trigger 303 is activated by the operator, the nozzle 306 is opened (either partially or fully opened) by the operator, while the trigger also acts to release pressurized gas so that it will exert force on the contents of the caulking tube, to express caulking through the nozzle 306.

In this embodiment, hollow handle piece 302 is removable, to allow an operator to load a pre-filled, high pressure CO2 cartridge into a chamber formed within the handle. The CO2 cylinder is secured within the chamber, and the cylinder is pierced to release CO2 gas from the cylinder, into a first reservoir (not shown) within the housing 309. The volume of the first reservoir is of sufficient size so that, in a preferred case, when the CO2 from the cartridge is emptied into the first reservoir, the pressure of CO2 is below the predetermined pressure limit for that reservoir.

A pressure regulator 310 is provided in fluid communicating arrangement between a first reservoir (not shown) in the housing 309 and a second reservoir (not shown), which second reservoir is also provided in the housing 309. A pressure relief valve 320 is provided in communication with the first reservoir to ensure that the pressure of the CO2 loaded into that reservoir does not exceed the predetermined maximum pressure for that reservoir, which in a preferred embodiment is about 200 psig. In this particular embodiment, the first reservoir is also fitted with a standard, one way air valve 330 (of the automotive tire type) to allow an operator to fill the first reservoir with compressed air, if the operator does not wish to use pre-filled CO2 cylinders to power the caulking gun. The air valve 330 may be coupled with air pumps, compressors and other powered sources of compressed air, to refill the first reservoir when desired.

In this embodiment, the second reservoir is also provided with a pressure relief valve 340 (which in some instances may be similar to an automotive air valve) to allow the operator to fully exhaust the compressed air or other gas from within the second reservoir, before the end cap 307 is removed from the caulking gun.

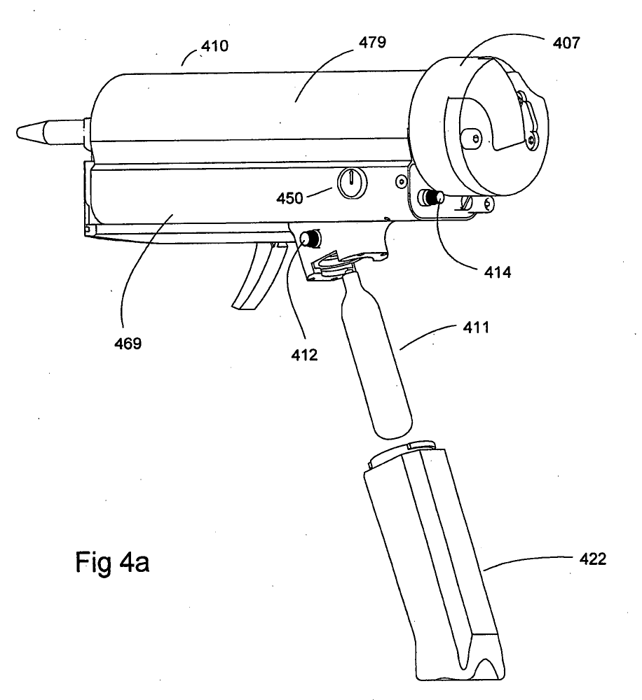

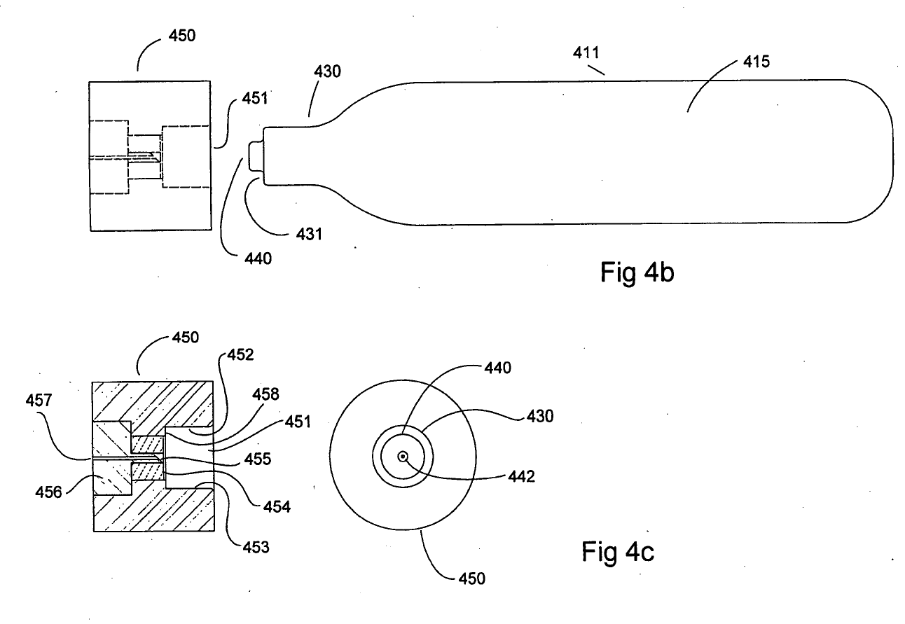

FIGS. 4a, 4b and 4c illustrate a further embodiment of the invention in which a hand held portable caulking gun 410 is powered by a replaceable CO2 cylinder 411 secured within a removable, hollow handle grip 422. The caulking gun 410 is provided with a housing 479 including a base portion 469 and removable end cap 407. In FIG. 4a, the illustrated dispensing device is provided with an actuating valve 412 which allows the operator to release gas from the pressurized gas source (which in this example is a CO₂ cylinder) into the R1 reservoir until the operator is alerted by pressure indicator 450 that the pressure with R1 has reached the desired pressure. In this example, a check valve 414 is open during the filling of the reservoir R1 and while the device is in use, dispensing viscous fluid from the tubular container. Valve 414 is closed when the operator removes or changes the tubular container with another to prevent undesirable loss of pressurized gas from within the device. The valve 414 may be a one way valve working in conjunction with the end cap 407 such that when the cap is fully secured to the device, the cap engages with the valve 414 to open the valve 414 to allow internal flow of the pressurized gas between reservoirs R1 and R2 during normal operation. When the end cap 407 is partially removed from the device, the cap disengages from the valve 414, disrupting the flow of gas between reservoirs R1 and R2. As the end cap is further disengaged, pressurized gas is released from reservoir R2, and the operator is then allowed to fully disengage the end cap, for safe removal of the used tubular container.

In some embodiments, a second end cap (defining a second interior chamber for storing pressurized gas) may be provided for use as a replacement for a first end cap (defining a first interior chamber for storing pressurized gas). The end caps may be interchangeably secured to the dispensing device to provide the device with different storage volumes for the pressurized gas. It will be understood that other features, including other interchangeable elements, may be employed to allow an operator to modify the internal storage volume of a dispensing device

In some embodiments, it may be desirable to utilize standard CO2 cartridges (typically in sizes containing about 6 grams, 12 grams and 18 grams of CO2) manufactured for use in various powered items, including air guns and the like. In other instances, it may be desirable to use CO2 cartridges having different configurations, sizes and capacities. Also, it may be important in some instances to provide a feature to prevent operators and users from accidentally loading the tool with incompatible pressurized CO2 cartridges.

In some embodiments, the dispensing device may be optimally designed so that the CO2 cartridge will automatically discharge into the first reservoir to achieve the predetermined pressure P1, without any significant waste of CO2. The volume of R1 may be optimized to receive a maximum amount of CO2 from the cartridge, and achieve a pressure up to the predetermined pressure P1 when the cartridge is securely loaded into the device.

Also, the volume of the second reservoir, R2, may be optimized so that a minimum effective amount of CO2 is charged into the second reservoir during operation. Thus, if the operator wishes to depressurize the second reservoir for any reason, only a relatively small amount of CO2 will be lost whenever the second reservoir is depressurized.

FIGS. 4b and 4c illustrate an embodiment of a modified CO2 cartridge 411 having a main body 415, a neck 430 and neck extension 440 protruding from the neck 430. Inlet piece 450 is typically made of a strong, resilient material, typically of a reinforced plastic or metal. Inlet piece 450 defines an inlet port 451 to receive neck 430 and neck extension 440 of the CO2 cartridge, preferably in a relatively snug, slide-fit arrangement, when the cartridge 411 is completely loaded within the caulking gun handle. As the caulking gun handle is moved toward its fully closed position, the neck 430 of cylinder 411 will typically move inwardly toward inlet port 451, so that side walls 452, 453 of the inlet port will center neck extension 440 in alignment with recessed needle 455 which is supported on a needle base 456. The needle 455 and needle base 456 define an interior inlet channel 457 to supply pressurized CO2 to an interior first reservoir R1 (not shown in this embodiment). As the CO2 cartridge is fully loaded into the handle grip, needle 455 will puncture the seal formed by neck extension 440 to create an opening 442 in the CO2 cartridge. The CO2 cartridge will be blocked against further inward travel as shoulder 431 of neck 430 abuts against abutment 458 within inlet port 451. A flexible, yet resilient annular seal 454 is provided around needle 455 to inhibit leakage of CO2 from the connection point between the CO2 cartridge and the needle 455. The relative sizes and configurations of the nesting features of the inlet piece 450 and the CO2 cartridge may be selected so that standard sizes or commonly used sizes of CO2 cartridges will not be punctured when accidentally loaded into the working tool.

The foregoing are examples of certain aspects of the present invention. Many other embodiments, including modifications and variations thereof, are also possible and will become apparent to those skilled in the art upon a review of the invention as described herein. Accordingly, all suitable modifications, variations and equivalents may be resorted to, and such modifications, variations and equivalents are intended to fall within the scope of the invention as described herein and within the scope of any issued patent claims.

1. A hand held device for dispensing a viscous fluid from a replaceable container within the device, the device comprising:
a first reservoir for containing a pressurized fluid at a first operating pressure less than a first predetermined pressure, the first reservoir comprising an inlet for introducing the pressurized fluid from a pressurized fluid source;
the pressurized fluid expresses the viscous fluid from the replaceable container when the pressurized fluid is released; and
the device defining a storage volume for an effective amount of the pressurized fluid sufficient to discharge substantially all of the viscous fluid from the replaceable container.

2. A hand held dispensing device comprising:
a sealable chamber for receiving a cylindrical container of dispensable viscous fluid;
a nozzle defining a tip for selectively dispensing the viscous fluid from the chamber;
a first reservoir for containing a pressurized fluid below a first predetermined pressure, the first reservoir comprising an inlet for introducing the pressurized fluid from a pressurized fluid source;
a second reservoir for containing the pressurized fluid below a second predetermined pressure, the second reservoir being in fluid communication with the first reservoir, and the second predetermined pressure being less than the first predetermined pressure; and
the pressurized fluid within the second reservoir operating to express the viscous fluid from the sealable chamber via the nozzle tip.

3. A hand held dispensing device comprising:
a cylindrical housing defining a sealable chamber for receiving: a cylindrical container of dispensable viscous fluid, the sealable chamber extending along a longitudinal axis and between a first end and a second end of the housing;
a nozzle adjacent the first end of the housing, the nozzle operating between a closed position and an open position;
a hand operated first control for operating the nozzle between the closed position and the open position;
a first reservoir for containing a pressurized fluid below a first predetermined pressure, the first reservoir comprising an inlet for introducing the pressurized fluid from a pressurized fluid source;
a second reservoir for containing the pressurized fluid below a second predetermined pressure, the second reservoir being in fluid communication with the first reservoir, and the second predetermined pressure being less than the first predetermined pressure;
the second reservoir being in fluid communication with the sealable chamber, to express the viscous fluid toward the first end when the cylindrical container is sealed within the sealable chamber; and
a hand operated second control for introducing the pressurized fluid into the second reservoir.

4. The device claimed in claim 1, wherein the first predetermined pressure is less than or equal to 150 psig (1030 kPa).

5. The device claimed in claim 2, wherein the second predetermined pressure is less than or equal to 80 psig (550 kPa).

6. The device claimed in claim 1 comprising a pressure relief valve for selectively exhausting an excess amount of pressurized fluid from the first reservoir if the pressure in the first reservoir exceeds the first predetermined pressure.

7. The device claimed in claim 2 comprising a pressure relief valve for selectively exhausting an excess amount of pressurized fluid from the second reservoir if the pressure in the second reservoir exceeds the second predetermined pressure.

8. The device claimed in claim 1, comprising a storage compartment for a replaceable gas cylinder, the gas cylinder defining the pressurized fluid source.

9. The device claimed in claim 1, wherein the pressurized fluid source is defined by a hand operated air pump.

10. The device claimed in claim 1 for selective fluid communication of the pressurized fluid to dispense the viscous fluid, without a pressure regulator to control an operating pressure of the pressurized fluid within the device.

11. The device claimed in claim 1 comprising an expandable gas impermeable protective inner liner within the first reservoir.

12. The device claimed in claim 1, wherein the first reservoir is defined by a removable chamber.

13. The device claimed in claim 12, wherein the removable chamber is interchangeable with a second chamber, the removable chamber defining a first pressurized fluid storage space less than a second fluid storage space defined by the second chamber.

14. The device claimed in claim 1, comprising a handle portion, the handle portion defining the first reservoir.

15. The device claimed in claim 1, wherein the first predetermined pressure is less than or equal to 200 psig (1380 kPa).

16. The device claimed in claim 2, wherein the second predetermined pressure is less than or equal to 60 psig (410 kPa).

17. The device claimed in claim 1, wherein the first predetermined pressure is between 80 psig (550 kPa) and 250 psig (1720 kPa).

18. The device claimed in claim 2, wherein the second predetermined pressure is between 10 psig (70 kPa) and 80 psig (550 kPa).

19. The device claimed in claim 1 capable of receiving a prefilled cartridge of pressurized gas; and essentially all of the pressurized gas discharging into the first reservoir when the cartridge is securely loaded into the device.

20. The device claimed in claim 2, wherein the device defines a storage volume for receiving an effective amount of pressurized gas sufficient to dispense substantially all of the viscous fluid.
